(19) United States
(12) Patent Application Publication
(10) Pub. No.: US 2015/0142826 A1
(43) Pub. Date: May 21, 2015

(54) Systems and Methods for Management and Improvement of Romantically Linked Relationships

(71) Applicant: Moxbi, LLC, Mableton, GA (US)

(72) Inventors: Syed E. Haider, Mableton, GA (US); Jason Rhoades, Atlanta, GA (US); Dylan C. Townsend, San Jose, CA (US); Christopher Romano, Hillsborough, NJ (US)

(21) Appl. No.: 14/546,788

(22) Filed: Nov. 18, 2014

Related U.S. Application Data
(60) Provisional application No. 61/907,376, filed on Nov. 21, 2013.

(51) Int. Cl. G06F 17/30

(52) U.S. Cl. CPC G06F 17/3053
USPC 707/748

(57) ABSTRACT

A system and method for managing and improving a romantically linked relationship allows each partner in the relationship to self-report and enter quantitative measures related to various dimensions of their relationship. The quantitative data entered by both the partners is used to compute the romantically linked couple's relationship satisfaction scores based on a statistically derived algorithm. Each partner may also be allowed to embed digital media content related to their relationship from their pre-existing social media accounts to further contextualize their relationship information. The relationship information provided by each partner is combined and preserved in the couple's online relationship chronicle that can be referred back and viewed by both partners. The relationship satisfaction scores, along with their component parts, are charted on a chronological scale such that the scale provides trending information, enabling further analysis related to the couple's relationship dynamics.

This application claims priority to U.S. provisional patent application No. 61/907,376, entitled Systems and Methods for Management and Improvement of Romantically Linked Relationships, filed on Nov. 21, 2013, the entire contents of which are incorporated herein by reference.

### BACKGROUND

Various aspects of the present invention relate to the field of relationship management and improvement. Additionally, aspects of the present invention may be applied to the field of relationship counseling and couples' therapy. Various aspects of the invention also relate to the field of cloud-based online relationship management and improvement tools for individuals in romantically linked relationships.

There have been numerous research efforts in the field of social psychology to ascertain the quality of romantically linked relationships by attaching quantitative metrics as a means to gauge overall relationship satisfaction. A study in 1976 by Dr. Graham Spanier introduced the concept of the “Dyadic Adjustment Scale” (DAS), a measure for assessing the quality of marital relationships. (Spanier, Graham B. 1976. “Measuring Dyadic Adjustment: New Scales for Assessing the Quality of Marriage and Similar Dyads.” Journal of Marriage and the Family. 38: 15-28). A “dyad” is a term of art in sociology and psychology disciplines that refers to a group with two individuals—the smallest, irreducible social group. The relationship or interactions between the two individuals in a dyad is referred to as a “dyadic relationship.” The DAS utilized a method of self-reported measures based on a 32-item scale, grouped into four sub-scales, that was designed to be used with married or unmarried cohabitating couples. The DAS technique, as a measure of relationship quality, has since been widely studied and validated. (Hendrick, Susan S. 1988. “A Generic Measure of Relationship Satisfaction.” Journal of Marriage and the Family. 50: 93-98 and Carey, Michael P., Spector, Ilana P., Lantinga, Larry J., & Krauss, Dennis J. 1993. “Reliability of the Dyadic Adjustment Scale.” Psychological Assessment. 5: 238-240). While adjustments have been proposed for the scale, to date it remains a popular method of psychometric analysis for romantically linked couples. (Busby, Dean M., Christensen, Clark, Crane, D. Russell, & Larson, Jeffry H. 1995. “A Revision of the Dyadic Adjustment Scale for use with Distressed and Non-Distressed Couples: Construct Hierarchy and Multidimensional Scales.” Journal of Marital and Family Therapy. 21: 289-308).

In recent years, advancements in digital communications such as broadband internet and voice-over-internet-protocol (VoIP) have enabled mental health practitioners to offer their counseling services to couples in an online real-time setting, utilizing technologies that include instant text messaging, voice teleconferencing and video conferencing. Additionally, the onset of online social media and the proliferation of hand-held mobile devices have prompted the development of online services and mobile applications that enable romantically linked couples to communicate their feelings and emotional connection regarding their relationship with their respective partners within a social media framework. Such online services and mobile applications include Tokii, Kahnoodle, and TheIceBreak. These services are designed to increase the level of interaction and engagement between the partners through virtual online means in an effort to improve the overall quality of their relationship.

### SUMMARY

An embodiment of the invention is comprised of a cloud-based online platform to monitor, diagnose, and improve the quality of relationship between two individuals in a romantically linked relationship.

An embodiment of the invention implements a rules-based engine utilizing a modified form of the DAS technique within an online environment. It allows each partner in the relationship to self-report and enter quantitative measures related to various dimensions of their relationship, supplemented with contextualized qualitative information, in a chronologically updated online log. The quantitative data entered by both the partners is used to compute the romantically linked couple's relationship satisfaction scores based on a statistically derived algorithm. The embodiment also allows each partner to embed digital media content related to their relationship from their pre-existing social media accounts to further contextualize their relationship information (e.g., Facebook posts and pictures, Twitter tweets, YouTube videos). The relationship information provided by each partner is combined and preserved in the couple's online relationship chronicle that can be referred back and viewed by both partners. The relationship satisfaction scores, along with their component parts, are charted on a chronological scale such that the scale provides trending information, enabling further analysis related to the couple's relationship dynamics.

From a privacy standpoint, the couple can elect multiple privacy settings. In the most private circumstance, the couple can choose to keep their relationship information completely private, i.e., only between themselves. In certain other privacy settings, the couple can choose to share select portions of their relationship data/information with other couples that the partners have jointly selected to be in their social network. The sharing of online relationship information among couples within a social network can provide an online forum that enable group discussions and mutual dialog among couples. These online interactions can allow couples to better understand their relationship dynamics, to address relationship issues and difficulties, and to share instances of past successes. An embodiment also allows couples to present their relationship information to participating relationship counseling practitioners (relationship counselors and couples' therapists) within the network. Utilizing the couple's relationship information enables the practitioner to gain greater insights about the couple's relationship dynamics and thereby enhances the delivery of counseling or therapy services.

The system can provide couples with a platform to communicate and assess relationship dynamics and resolve issues based on criteria that are mutually important to both partners. The relationship information that is self-reported by the partners can be presented in a form that is both engaging and data rich such that it is useful for self-analysis and as well as for the counseling professional. One feature of the system is that it eliminates or minimizes system generated biases that may advantage one partner over the other, thereby enabling both partners to have an equal say in the assessment of their relationship.

### BRIEF DESCRIPTION OF THE DRAWINGS

FIG. 1A is a flowchart that illustrates an Account Setup/On-Boarding process of a system according to one embodiment.

FIG. 1B is a flowchart that illustrates a Service Settings Selection process of a system according to one embodiment.

FIG. 1C is a flowchart that illustrates a Relationship Scoring & Information Entry process of a system according to one embodiment.

FIG. 1D is a flowchart that illustrates a Relationship Visualization process of a system according to one embodiment.

FIG. 1E is a flowchart that illustrates a Relationship Discontinuation & Archival process of a system according to one embodiment.

FIG. 2 illustrates a conceptual layout of certain components of the Service Settings according to one embodiment.

FIG. 3 provides a tabular listing of 47 Relationship Dimension choices that are categorized into six Relationship Dimension Categories according to one embodiment.

FIG. 4 describes four scenarios of joint Relationship Dimension selections of a couple arising from the individual selections of the partners and applying the operational rules according to one embodiment of the system.

FIG. 5 provides a walk-through example of a scoring methodology used to compute the Relationship Satisfaction Score according to one embodiment.

FIG. 6 provides a walk-through example of a scoring methodology used to compute the Relationship Satisfaction Score according to one embodiment.

FIG. 7 provides an illustration of a Welcome screen for a user's account according to one embodiment.

FIG. 8 provides an illustration of a Profile screen where a user enters detailed demographic information according to one embodiment.

FIG. 9 provides an illustration of a Service Settings screen where a user can select, alter or change service settings that govern the method or mode of system operation according to one embodiment.

FIG. 10 provides an illustration of a Relationship Scores, Commentaries and Associated Social Media entry screen where a user enters data/information about a relationship according to one embodiment.

FIG. 11 provides an illustration of a Detailed Score Entries screen, which is a visualization of relationship data/information entered by both or one partner for a given date according to one embodiment.

FIG. 12 provides an illustration of a couple or partner's Relationship Chronicle screen, which is a graphical representation of relationship scores charted on a chronological scale according to one embodiment.

FIG. 13 provides an illustration of a Relationship Archival screen by which a user is able to discontinue service by either archiving the relationship data for possible later retrieval or permanently deleting it according to one embodiment.

### DETAILED DESCRIPTION

### Introduction

An embodiment focuses on the creation of a cloud-based online platform that enables a user to log a wide array of information about various aspects of a romantically linked relationship that corresponds to the overall satisfaction of the relationship. The embodiment allows the user to interact online with a romantic partner to mutually communicate feelings regarding the relationship, to better comprehend relationship dynamics, and to jointly address relationship issues. The inputs provided by each partner can follow a set of operating rules described below. The analytical framework of the relationship dimensions can be based on a modified form of the DAS technique, while the algorithm used to compute the couple's relationship satisfaction is based on statistically derived methodologies.

### Service Flow

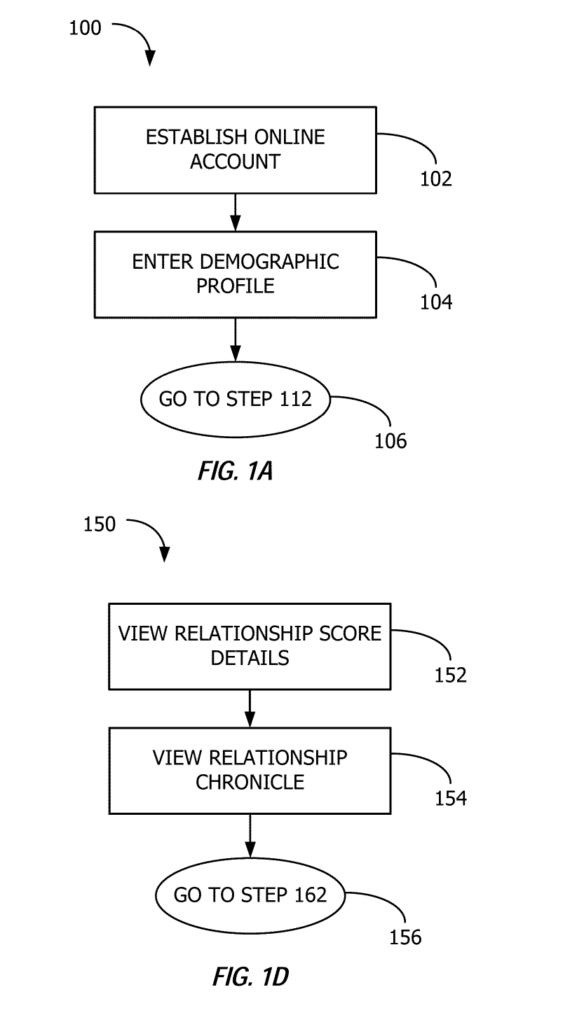

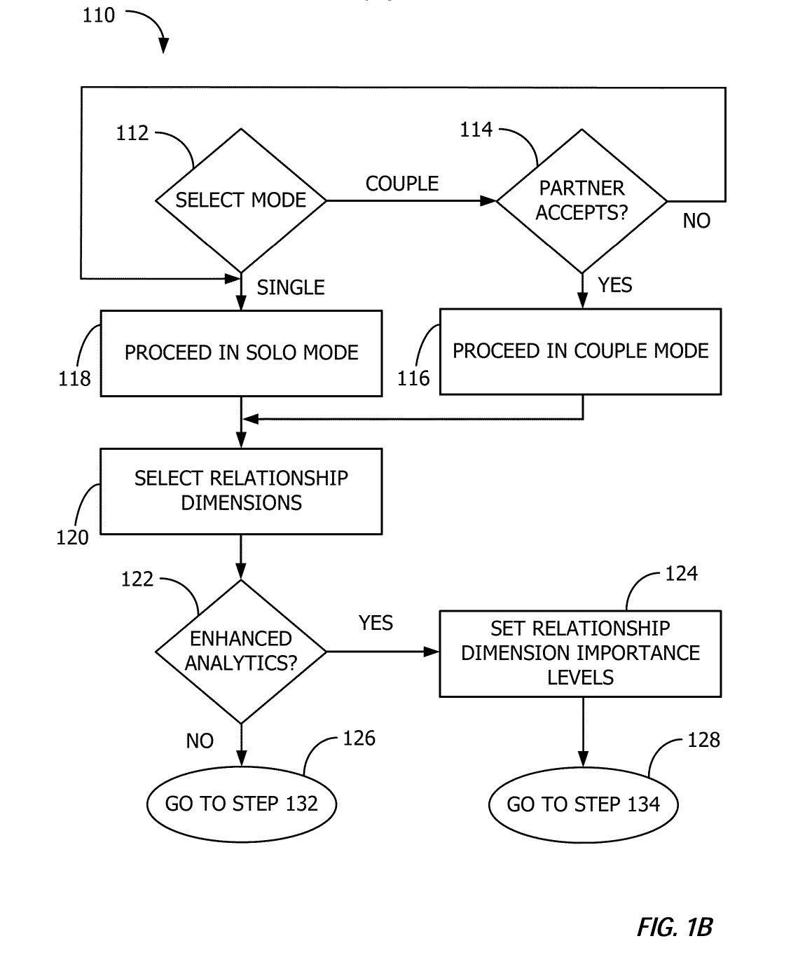

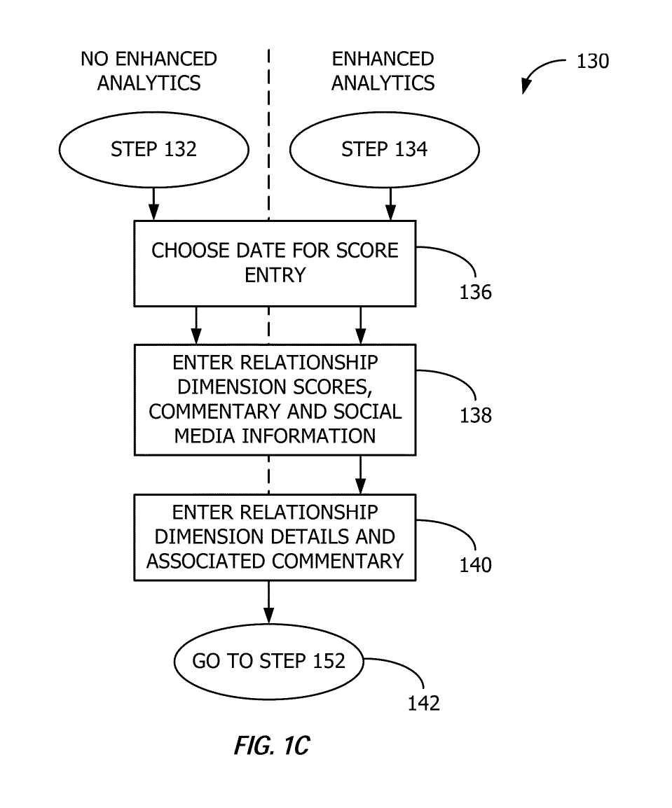

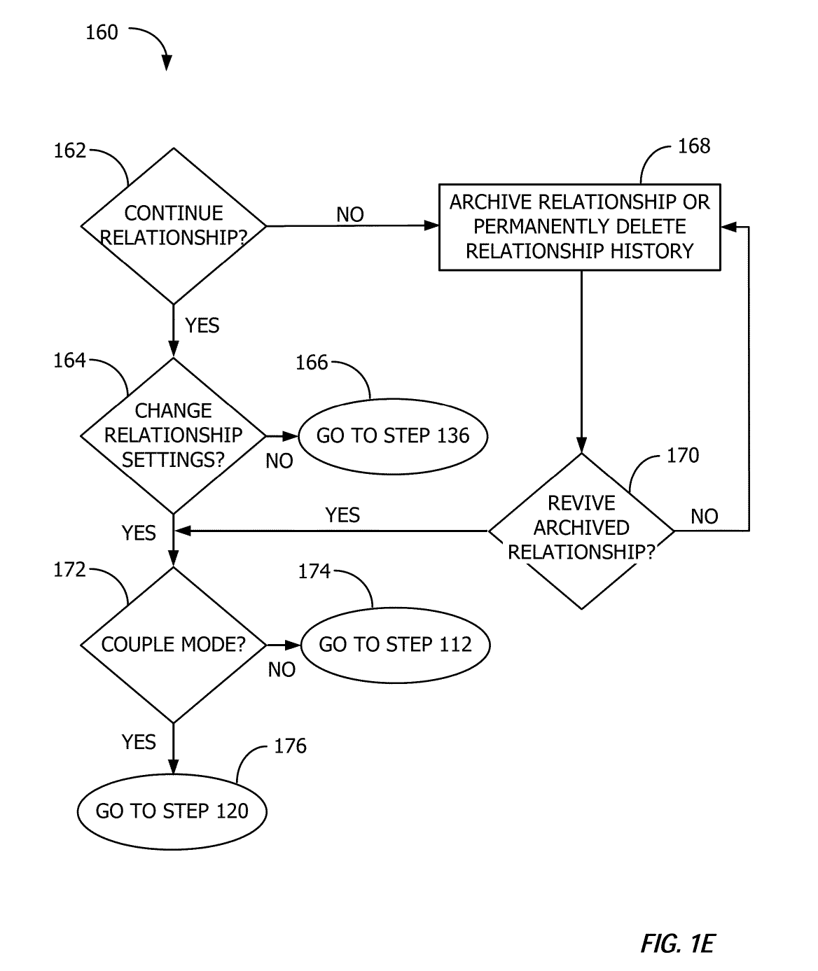

An overall service flow of an embodiment of the system is depicted in FIGS. 1A-1E. The service flow accounts for operation in either “Solo Mode” (Partner “A” and Partner “B” using the platform individually by themselves) or “Couple Mode” (both Partner “A” and “B” using the platform together as one). The entire service flow can be sub-divided into five sections: 1. Account Setup/On-Boarding, 2. Service Settings Selection, 3. Relationship Scoring & Information Entry, 4. Relationship Visualization, 5. Relationship Discontinuation & Archival, which correspond to FIGS. 1A-1E, respectively. Aspects of each of these five sections are described below.

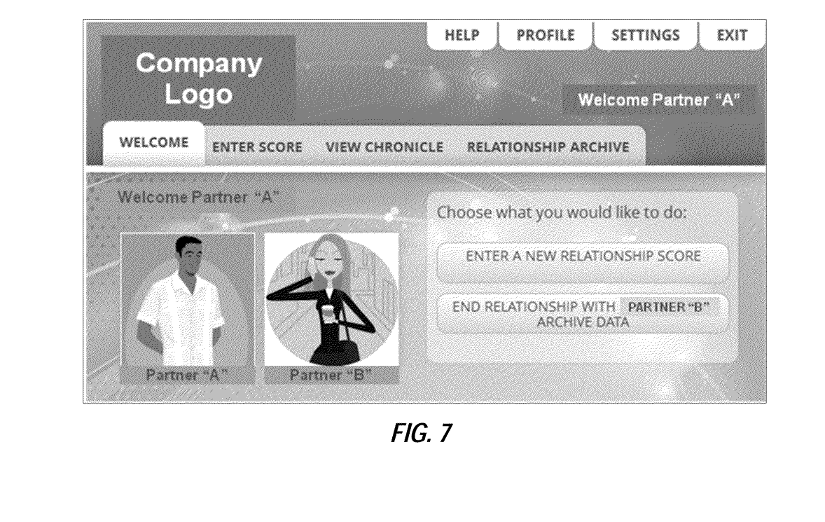

As illustrated in the Account Setup/On-Boarding process 100 depicted in FIG. 1, the system can initially require each partner to set up their individual account (102). At account setup, the system establishes the account holder's basic identity information: for example, name, email address and password. The system also prompts the user for a relationship partner. Upon successful account setup, the user can be directed to a “Welcome” page, such as the page illustrated in FIG. 7. The Welcome page can be the default landing page after account signup and can allow the user to navigate to other areas of the user's account.

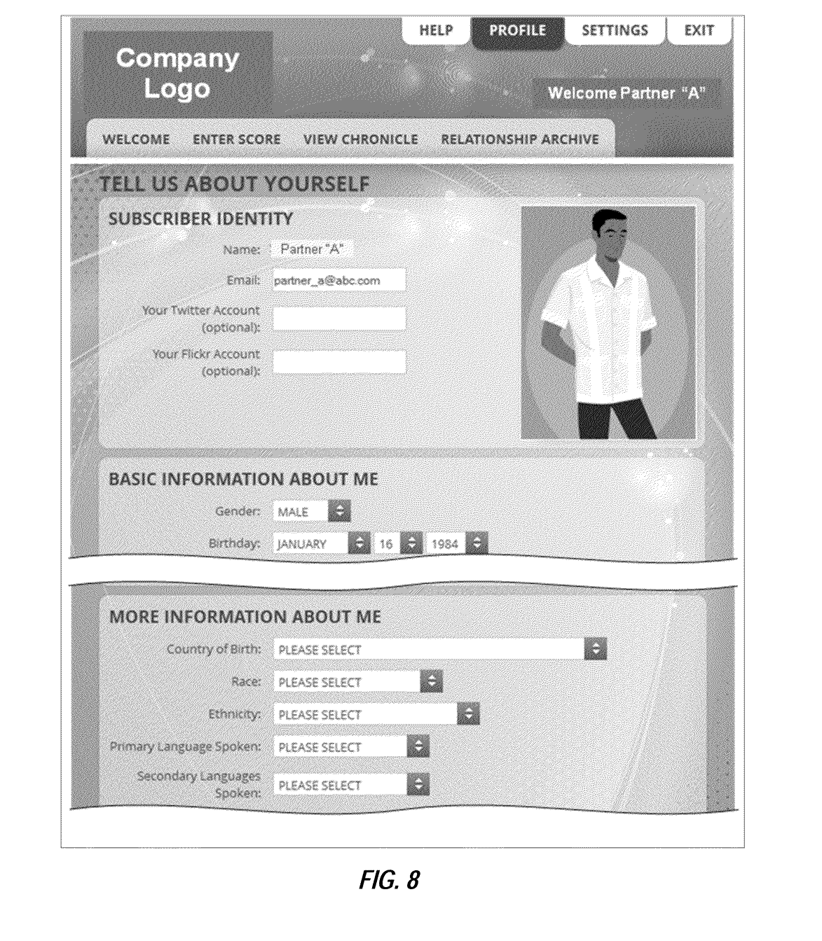

Another step in the setup process is for the user to enter their detailed demographic profile (104). In one embodiment, this may be accomplished via an interface such as that illustrated in FIG. 8. Providing demographic information enables the user to statistically compare their relationship measures versus their peer group or other similar demographic groupings.

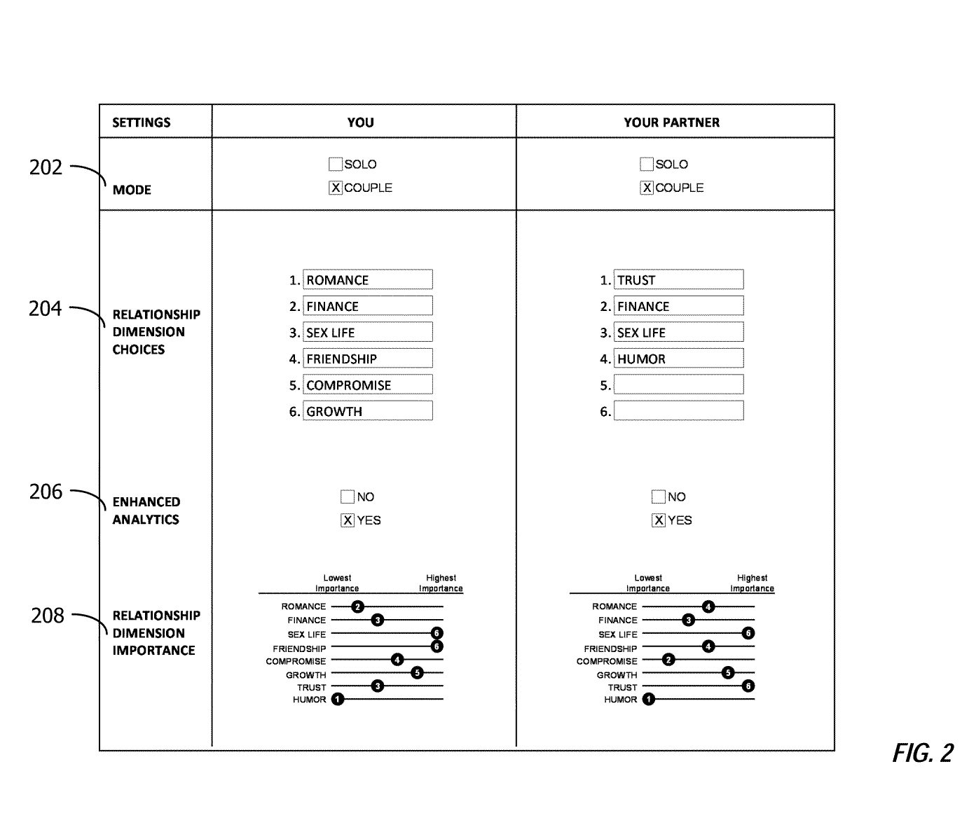

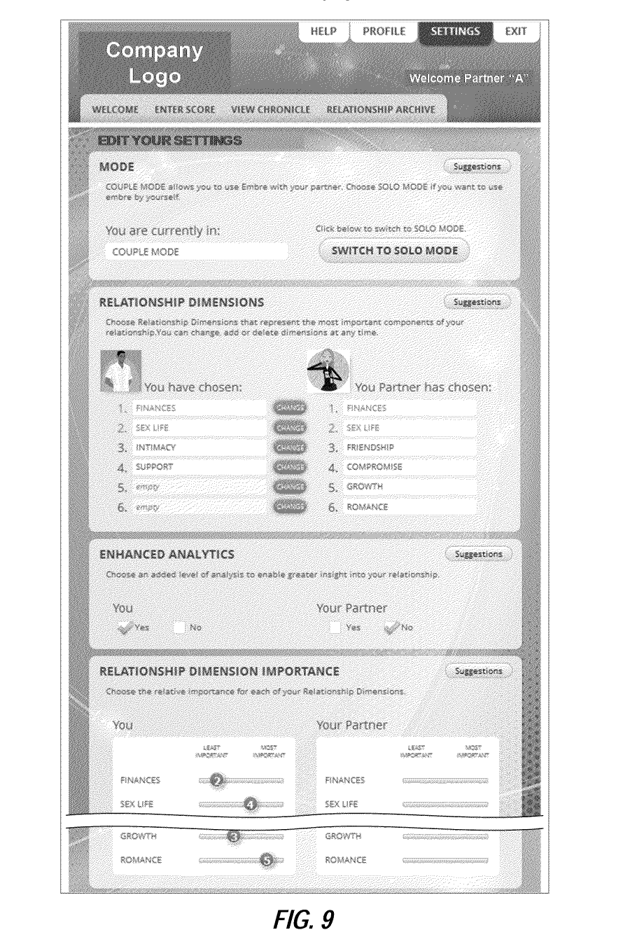

FIG. 1B illustrates a Service Settings Selection process 110 by which a user selects an operating mode and determines the relationship dimensions by which the relationship will be assessed. An exemplary selection of the settings is shown in FIG. 9. The settings selection governs the method of operation, including the dimensions of the relationship that the user deems significant by which to assess their relationship. A conceptual layout of four components (202, 204, 206, and 208) of the service settings is shown in FIG. 2.

In the Service Settings process 110 depicted in FIG. 1B, a user first selects an operating mode (112). Two modes of operation for the service can be “Solo Mode” and “Couple Mode.” In Solo Mode a user records the relationship information solely for him or herself and does not interact with the partner. Solo Mode can provide the user with an avenue to chronicle a relationship without the active involvement or participation of the partner. Therefore, in Solo Mode, both partners can separately track their relationship in individually maintained Solo Mode accounts.

Couple Mode allows both partners to combine their individual accounts into a unified account, and entries from both partner accounts can be viewed by either partner. The system can allow Solo Mode accounts to be converted to Couple Mode accounts, comingling past entries from both partners' solo accounts into a unified couple account. If a user selects Couple Mode (the “Couple” prong of block 112), a request is sent to the user's partner. If the partner accepts the request (the “Yes” prong of block 114), both partners' solo accounts are joined together in a co-mingled couple account. As long as the partner does not accept the request (the “No” prong of block 114), the accounts continue to operate as solo accounts. Conversely, a Couple Mode account can be separated or disentangled into two Solo Mode accounts. At account separation, the system which may be capable of tracking content ownership, can assign the content entries to the respective partners' accounts based on content ownership rights.

Therefore, using the methodology described above, the two partners could conceivably start off with separately maintained solo accounts, come together in a couple account, separate again into solo accounts, and repeat the cycle any number of times.

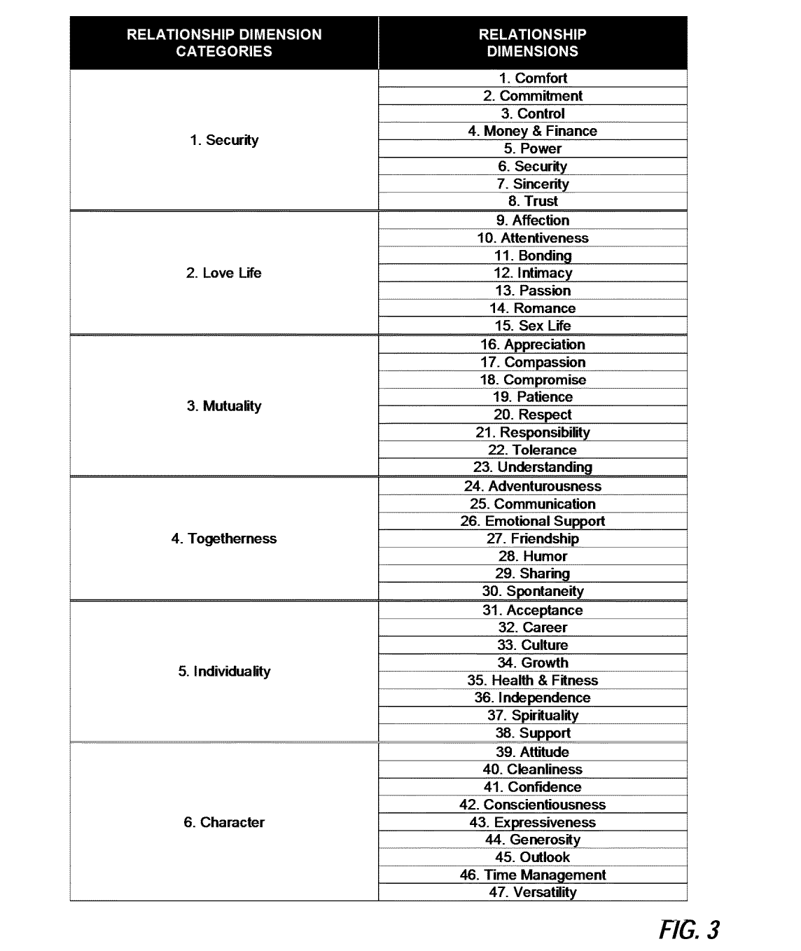

Process 110 further includes the selection of Relationship Dimensions by which a relationship can be assessed (120). Relationship Dimensions represent aspects of the relationship that a user chooses by which to assess a relationship. The user can apply a ranking to each of the selected Relationship Dimensions to indicate a level of satisfaction with the aspect of the relationship represented by the particular Relationship Dimension. In an embodiment, the ranking scale ranges from “6” as most satisfied to “1” as least satisfied. The individual Relationship Dimension rankings are used to compute the overall satisfaction score of the relationship, termed the “Relationship Score,” based on a statistically derived methodology. In an embodiment, there are 47 Relationship Dimensions sub-divided into six Relationship Dimension Categories, shown in FIG. 3. Other embodiments of the invention may include additional Relationship Dimension choices and Relationship Dimension Categories.

According to the operational rules of an embodiment, applicable during either Solo or Couple Mode operations, each partner may choose at least one Relationship Dimension and a maximum of six dimensions by which to assess their relationship. The system does not allow duplicate selections to be made by a user, however, it does allow for common or overlapping choices between the two partners. In addition, partners can select an unequal number of dimensions between them. The system can allow either partner to add, delete or change relationship dimension choices at any time without requiring the assent of their partner. In the event of a settings change, the system can notify the user's partner.

In one aspect of Relationship Dimension selections between the two partners, not only does the user assess the relationship based on their Relationship Dimension selections but also that of their partner's Relationship Dimension selections. In this way, the system can implement a methodology of relationship assessment where both partners mutually assess their relationship based on the criteria that are chosen by both and that which are important to both.

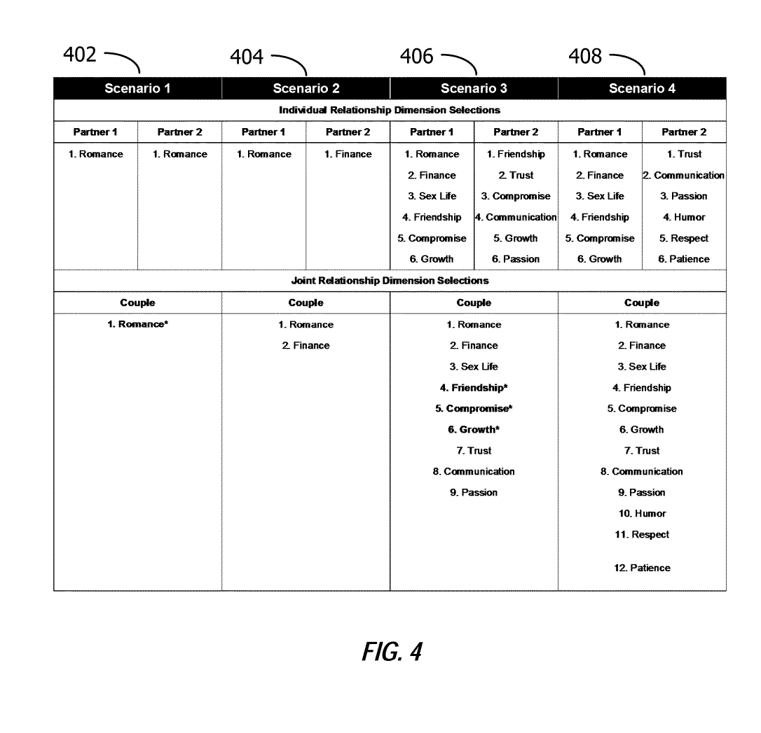

FIG. 4 illustrates example scenarios of joint relationship dimension selections between partners when applying the operational rules as outlined above. In Scenario 1 (402), each partner has selected one relationship dimension, the minimum number allowable in one embodiment. Since the choices are common or overlapping between the two partners, it results in a joint selection of one dimension for the couple. In Scenario 2 (404), while both partners have selected the minimum number of dimensions, the choices are different, resulting in a joint selection of two dimensions. In Scenario 3 (406), both partners have selected six dimensions, the maximum allowable in one embodiment. Since they have three choices in common between them, it results in a joint selection of nine dimensions as a couple. In Scenario 4 (408), both partners have selected six dimensions with none in common between them, resulting in a joint selection of 12 dimensions. Therefore, as illustrated in the scenarios, applying the operational rules of one embodiment of the system, in Solo Mode, a user can have a minimum of one dimension and a maximum of six non-duplicate dimensions. In Couple Mode, a couple can have a minimum of one dimension and a maximum of 12 non-duplicate dimensions—criteria by which to assess their relationship satisfaction.

Returning to FIG. 1B, a user is additionally provided with a choice to select an Enhanced Analytics feature (122). The selection of the Enhanced Analytics feature offers the user the ability to apply individual weighting factors to their Relationship Dimension choices. The system can allow the user to select the Enhanced Analytics feature even though their partner may choose otherwise. The weighting factors are an indicator of the level of significance assigned by the user to any given Relationship Dimension. If unselected, then the Relationship Dimension choices are equally weighted. The Enhanced Analytics feature can provide the user with a more granular form of analytic capability. The developers of the original DAS technique had considered the possibility of adding weighting factors to the assessment model, although it was subsequently not implemented. One of the distinctions over the original DAS technique is that an embodiment incorporates weighting factor capabilities in the relationship assessment model.

If the Enhanced Analytics feature is selected (the “Yes prong of block 122), Relationship Dimension importance levels are selected (124). In one embodiment, the importance levels apply the individual weighting factors to the Relationship Dimension choices, with “6” as the most important and “1” as the least important.

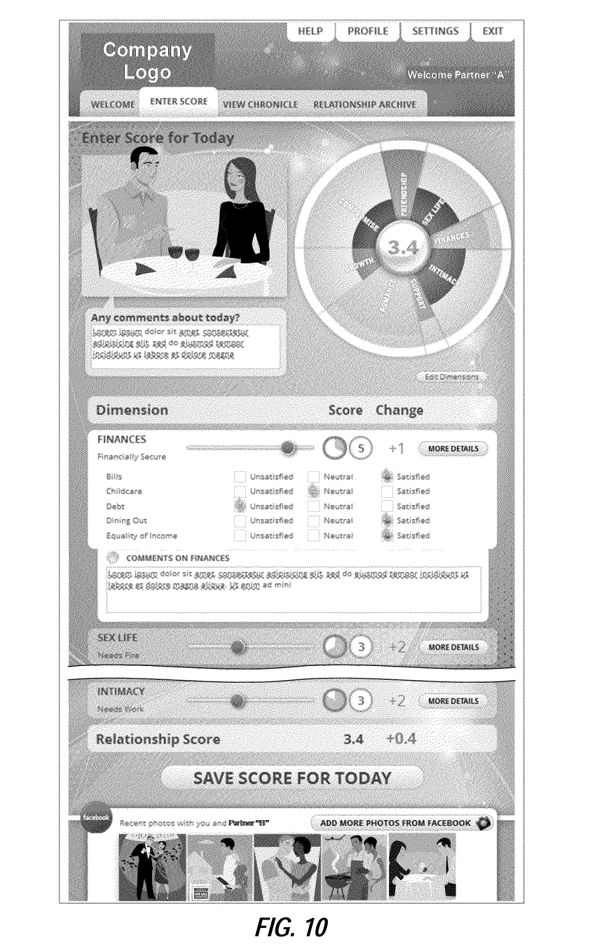

Referring to FIG. 1C, Relationship Scoring and Information Entry process 130 enables a user to select a particular date for relationship score entry (136) and to enter relationship dimension scores, commentary, and social media information (138). In addition, when the Enhanced Analytics feature has been selected, relationship dimension details and associated commentary may also be entered (140). In one embodiment, this process can be accomplished via an interface such as that illustrated in FIG. 10. FIG. 10 depicts a page where users can enter their relationship dimension score values, including contextualized commentaries and associated media from their social media accounts. The score entry interface may look and operate substantially the same for the Solo or Couple Mode accounts. If the Enhanced Analytics feature is selected, then the user can elect to provide additional details for each of the selected Relationship Dimensions. The additional detail allows the user to indicate those areas within a given dimension that are contributory factors affecting the satisfaction score. As an example, in FIG. 10, the additional detail window for the “Finance” Relationship Dimension is depicted.

According to the operating rules of an embodiment in Solo Mode, the system allows the user at any time to change, amend or alter entries for any present and past dates, including rankings, contextualized commentaries, dimensional details and associated social media content. In contrast, the service settings selection for a given date are “locked in” (unchangeable/unalterable) at the time an entry of any kind (score, commentary, etc.) is made by the user. If an entry is not made during the entire day, then the settings are automatically locked in at midnight as it transitions to the next date. Changes to the settings that are made on the same day after score entry apply on the following day, and remain changeable until either an entry is made or midnight of that day. In instances where entries are not made for several days, the settings for each day carry forward to the next day and successively get locked in as the day transitions past midnight.

In similar fashion, changes to entries in Couple Mode can be made by both partners at any time for any present and past dates. The service settings selections for both partners are locked in if either partner makes an entry in the Couple Mode account. If neither partner makes an entry for the entire day, then at midnight the settings for both partners are automatically locked in, just as in the Solo Mode case. The system of locking in the settings selections freezes in place the Relationship Dimension choices and the Relationship Dimension weighting factors for any given date. One aspect of the service, as described above, resolves any operating conflicts that may arise from couples making retroactive changes to the settings values. The scenario where settings could be changed for past dates may potentially lead to a situation where retroactive changes to Relationship Dimensions selections by one partner results in the partial deletion of scores for the other, thereby conceivably advantaging one partner over the other. Consequently, a user could potentially use the loophole to game the system to advantage themselves over their partner; for this reason, settings changes may be disallowed after score entries are made or if the date transitions to the next day. In contrast, the ability to alter one's score entries does not open the system to be manipulated in a similar fashion. Thus, retroactive changes to score entries may be allowed by the system so as to maximize partners' flexibility to reassess their relationship satisfaction for any particular date in the past.

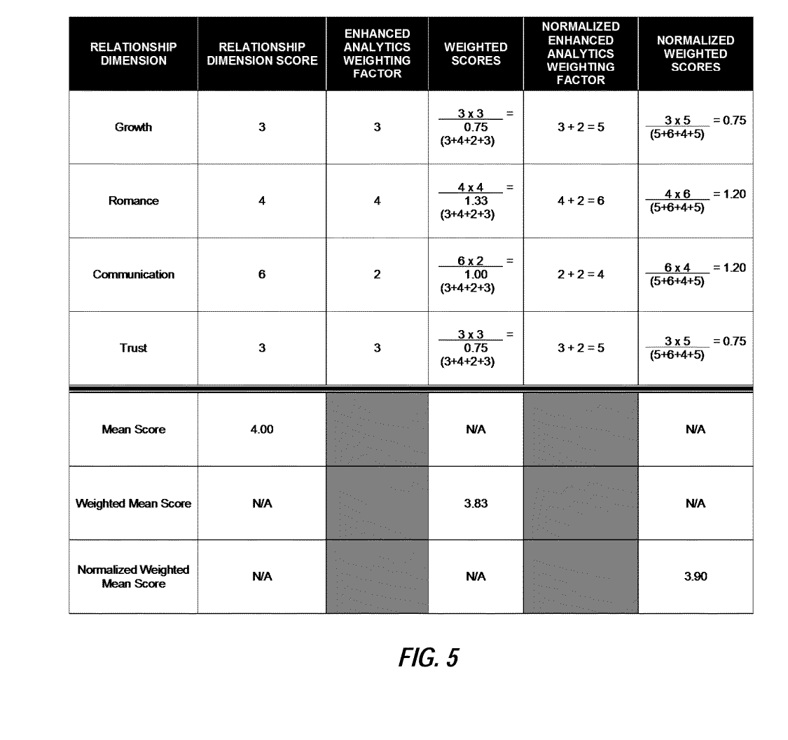

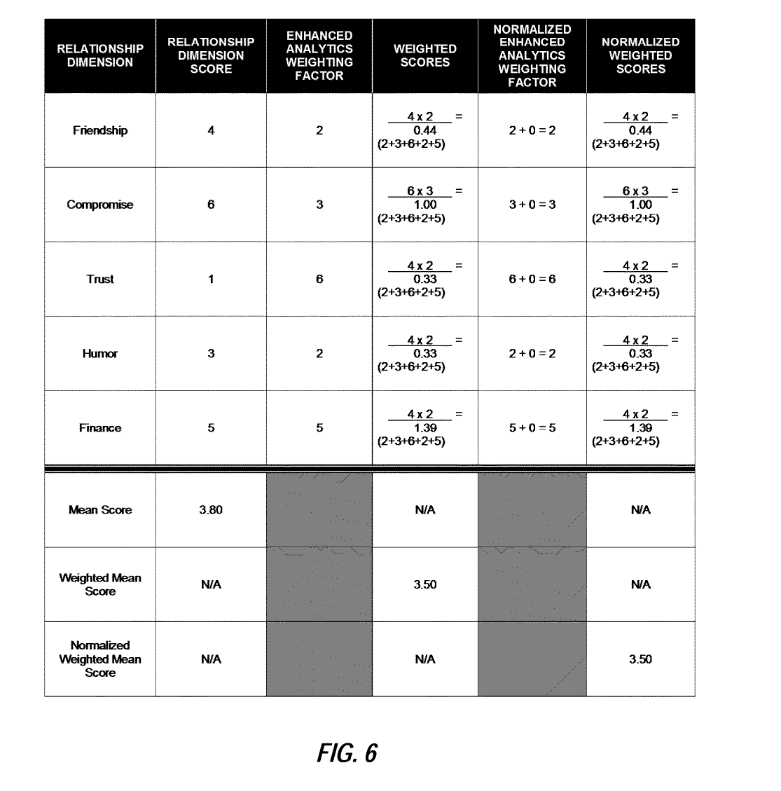

A scoring methodology to arrive at the overall relationship satisfaction, the couple's “Relationship Score,” can be based on statistical principles, combined with a normalization procedure to factor out any system generated biases that might advantage one side over the other. FIGS. 5 and 6 provide a walk-through of two example scenarios of the scoring methodology. In the first example (FIG. 5), the “Mean Score” is the statistical average of the individual score values of four Relationship Dimensions. The “Weighted Mean Score” is the weighted average that factors in the individual weighting factors (Relationship Dimension Importance) that the user applies to each Relationship Dimension. The next step is the normalization procedure in which the weighting factor values are rescaled where the highest weight is reset upward to a value of 6, and the other weighting factors adjust upwards relative to the highest value. In this example, “Romance,” which has the highest weighting factor of 4, is reset upward to 6 and the other factors are reset accordingly. The normalization step may equalize the weighting scales for both partners, thereby minimizing any system generated advantages gained by the use of dissimilar weighting scales. As a result, in the FIG. 5 example, the Mean Score is 4.00, the Weighted Mean Score is 3.83, and the “Normalized Weighted Mean Score” is 3.90.

The example in FIG. 6 follows a similar methodology. The difference in this case is that the highest weighting value is 6; therefore, it does not need to be reset upward. This results in the Weighted Mean Score and the Normalized Weighted Mean Score to be the same at 3.50. The overall Relationship Score for the couple is then the average of the two Normalized Weighted Mean Scores of the partners. In instances or dates when only one partner enters their score, the Relationship Score for the couple on that day is taken to be the Normalized Weighted Mean Score of the partner that entered the scores.

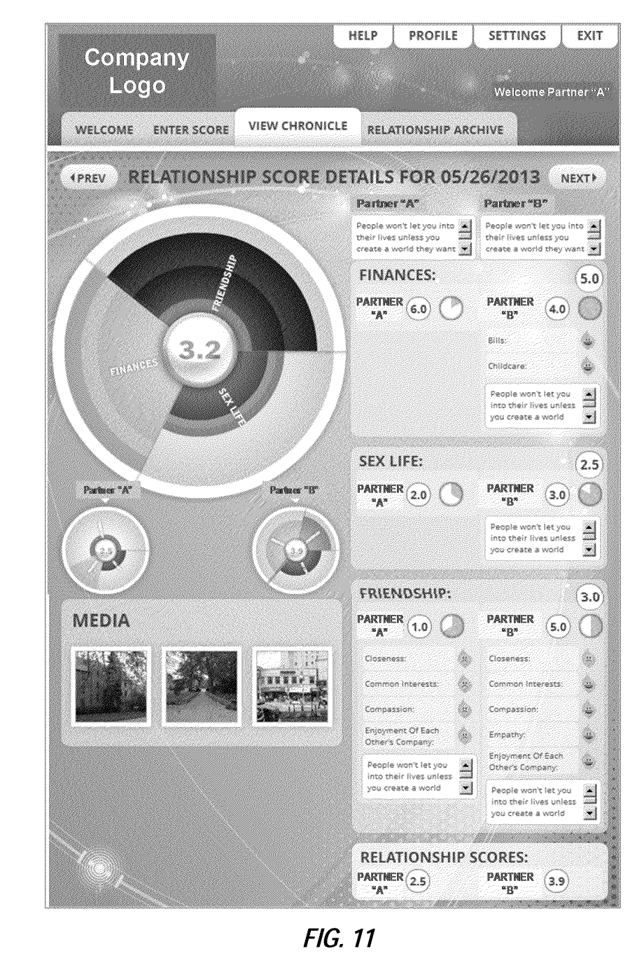

Referring to FIG. 1D, according to Relationship Visualization process 150, a user may view relationship score details (152) and a Relationship Chronicle (154). In one embodiment the consolidated relationship scores and related entries for both partners may be displayed, with Solo Mode and Couple Mode operating substantially in similar fashion. FIG. 11 depicts a “Detailed Entries” page, which in this example is a Couple Mode account showing scores, commentaries and associated media for Partner “A” and Partner “B.” In Solo Mode, only one partner's (the user) entries are displayed.

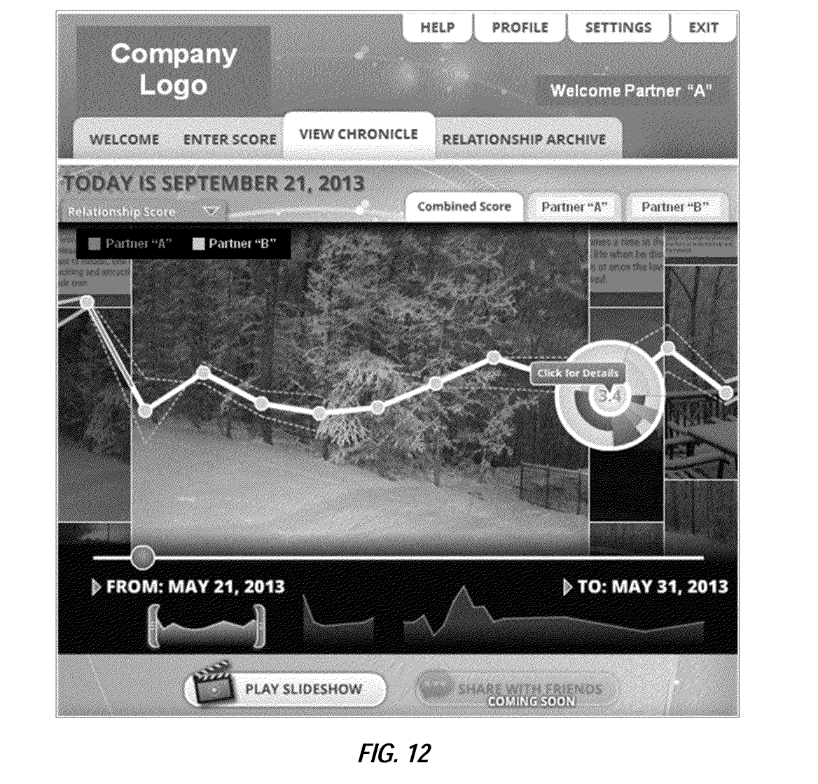

FIG. 12 is a graphical representation of a couple or partner's relationship scores charted on a chronological scale. The pictorial backdrop or “media wall” can be a system generated collage composed of the social media content provided by the user. In one embodiment, the social media content is associated with a relationship satisfaction score based on a common time period. The “Slideshow” feature can be a dynamic progression of the collage, displayed in chronological order, starting from the earliest date to the present. Collectively, the graphical representation, including the relationship score values and the associated media wall, is called the couple or partner's “Relationship Chronicle.”

The Detailed Entries and Relationship Chronicle pages, or selected portions based on privacy levels or settings, may be shared among other couples within a social network or with participating relationship counseling practitioners.

Referring to FIG. 1E, Relationship Discontinuation and Archival process 160 can provide a user a way to discontinue service. Service discontinuation could arise due to several factors, such as the dissolution of the relationship, a formation of a new relationship with another partner, or simply the desire to no longer participate in the service. If a user or users continue an existing relationship (the “Yes” prong of block 162), they may continue to utilize the Relationship Scoring and Information Entry and

Relationship Visualization processes as described with respect to FIGS. 1C and 1D, respectively. If, however, a user selects to discontinue a relationship (the “No” prong of block 162), they may be given the opportunity to archive the relationship or to permanently delete relationship history (168). When a relationship is archived, it may later be revived (the “Yes” prong of block 170), whereby the Service Settings Selection process 110 is resumed at either the mode selection step (112) or the relationship dimension selection step (120) depending on the selected mode.

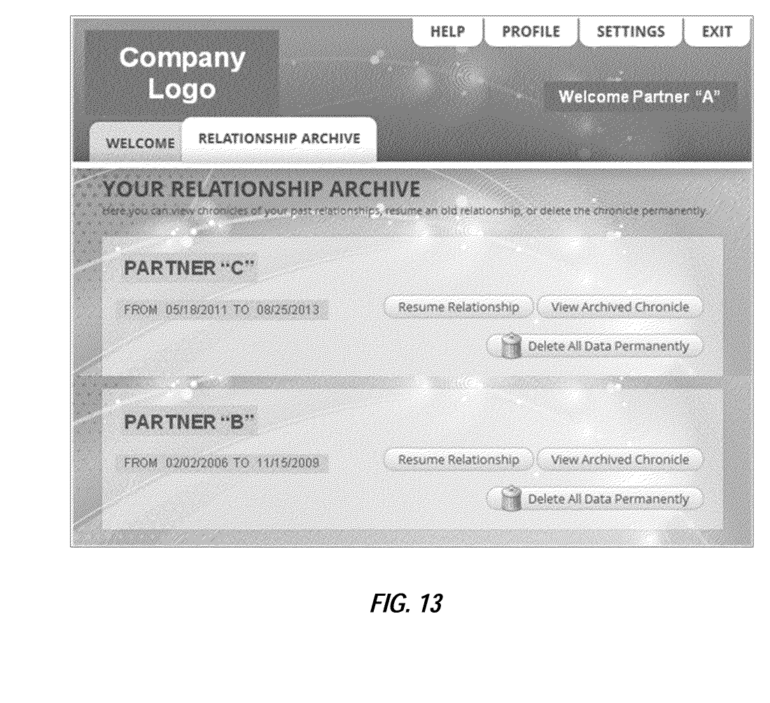

In Solo Mode, the decision to discontinue the service is made solely by the partner maintaining the solo account. The user can have an option to either archive the relationship information or permanently delete it, as shown in FIG. 13. The archival option preserves the relationship data in a dormant archived account, and the user retains the option to revive the account in the event the relationship is resumed at a future date. Also shown in FIG. 13 is an ability for the user to archive data from multiple relationships. In the case of deletion, all data associated with the relationship may be permanently deleted from the system.

In Couple Mode, either partner can elect to end the service or discontinue the Couple Mode account. If a partner initiates discontinuation procedures, then the other partner can be notified and the Couple Mode account can be immediately suspended. Both partners can be provided with the option to convert to individual Solo Mode accounts or archival or deletion. If a partner chooses to archive, then only their portion of the relationship data, based on their ownership rights, may be retained in their archived account. If the couple decides to resume to their relationship at a future date, then the archived content may be used to populate the revived account. However, if the data was permanently deleted, then it is as though they would be starting anew.

### CONCLUSION

While the embodiments described here refer to couples in romantically linked relationships (for example, marital/non-marital; cohabitating/non-cohabitating), the concepts described can be applied to a wide array of dyadic relationship types. For example, and without limitation, some other dyadic relationships may be: familial or fraternal bonds, common interests or affiliations, similar political ideologies, employment, etc. The relationship may be based on equality between the two parties or on an asymmetrical hierarchy such as that between an employer and employee, a supervisor and supervised, a teacher and student. It may also be applicable for relationship types that do not strictly adhere to a dyadic form such as a solitary relationship, i.e., a relationship with oneself, or a one-to-many relationship such as that between a celebrity and his or her fans, a sports team and its fans, a consumer brand and its brand adherents. As such, the present invention may be applied to relationships between two individuals or between an individual and a non-living entity (e.g. corporate entity, consumer brand entity, educational institution, political party).

One aspect of the described system provides partners within a romantically linked relationship the means to communicate with their respective partner areas where their relationship is working and where issues need to be worked out or resolved. A rules-based, data-driven mechanism is presented that indicates relationship satisfaction and its contributory factors, presented in an atmosphere devoid of overwrought, non-constructive emotionality that is typical of couples' arguments. Another aspect of the system is that it minimizes system generated biases and undue advantages garnered by one partner over the other, thereby providing both partners an opportunity to have an equal voice in the relationship.

1. A method, comprising:
providing a first user interface that enables a user to select one or more of a plurality of relationship dimensions, wherein each relationship dimension represents an aspect of a relationship;
providing a second user interface that enables the user to associate a ranking with each of the one or more selected relationship dimensions, wherein each ranking represents the user's level of satisfaction with the aspect of the user's relationship that is represented by the associated dimension;
computing a relationship satisfaction score based, at least in part, on the ranking associated with each of the one or more selected relationship dimensions; and
presenting the relationship satisfaction score to the user.

2. The method of claim 1, wherein the second user interface enables the user to assign an importance level to each of the one or more selected relationship dimensions.

3. The method of claim 2, wherein the act of computing the relationship satisfaction score further comprises weighting the ranking associated with one of the selected relationship dimensions based, at least in part, on the importance level assigned to the one of the selected relationship dimensions.

4. The method of claim 1, wherein the act of computing the relationship satisfaction score is repeated based on rankings that are provided by the user at different points in time.

5. The method of claim 4, further comprising preserving the relationship satisfaction scores that are computed based on the rankings that are provided by the user at different points in time.

6. The method of claim 5, wherein the act of presenting the relationship satisfaction score to the user comprises presenting the relationship satisfaction score to the user as a historical trend with past relationship satisfaction scores.

7. The method of claim 1, wherein the second user interface further enables the user to import content from a social media account of the user.

8. The method of claim 7, wherein the imported social media content is associated with the relationship satisfaction score.

9. The method of claim 1, wherein the acts of providing the first user interface and providing the second user interface are additionally performed to receive input from the user's partner in the relationship.

10. The method of claim 9, wherein the act of computing the relationship satisfaction score is additionally performed based, at least in part, on the input received from the user's partner.

11. The method of claim 10, wherein the act of presenting the relationship satisfaction score to the user further comprises presenting, to the user, the relationship satisfaction score that was computed based, at least in part, on the input received from the user's partner.
